(19) United States
(12) Patent Application Publication
(10) Pub. No.: US 2025/0288921 A1
(43) Pub. Date: Sep. 18, 2025

(54) FUMES PURIFICATION METHOD

(71) Applicant: POLITECNICO DI TORINO, Torino (IT)

(72) Inventor: Paolo Maria TRONVILLE, Torino (IT)

(73) Assignee: POLITECNICO DI TORINO, Torino (IT)

(21) Appl. No.: 18/861,229

(22) PCT Filed: May 2, 2023
(86) PCT No.: PCT/IT2023/050115

§ 371 Date: Oct. 29, 2024

(30) Foreign Application Priority Data
Apr. 29, 2022 (IT) 102022000008723

(51) Int. Cl. B01D 5/00; B01D 45/12; B01D 53/00

(52) U.S. Cl. CPC B01D 5/0003; B01D 5/0057; B01D 5/009; B01D 5/0096; B01D 45/12; B01D 53/002; B01D 2258/0275; B01D 2258/0283

(57) ABSTRACT

A method of purifying fumes with condensable gaseous contaminants is provided, including the steps of generating a flow of fumes to be treated in a heated area; cooling a structure receiving the flow of fumes so that the temperature of the structure is lower than that of the fumes to be treated to induce a condensation of the contaminants and to force a nucleation of the condensed contaminants; conveying said flow into an inertial separator unit for its purification. In particular, the structure is cooled by conduction through a natural and/or artificial cold thermal power source configured to stably and sensibly maintain its temperature below a fume temperature during the extraction of thermal power from the fumes by the structure.

### CROSS REFERENCE TO THE RELATED APPLICATIONS

This application is the national phase entry of International Application No. PCT/IT2023/050115, filed on May 2, 2023, which is based upon and claims priority to Italian Patent Application No. 102022000008723, filed on Apr. 29, 2022, the entire contents of which are incorporated herein by reference.

### TECHNICAL FIELD

The present invention refers to a high efficiency fumes purification method for low vapor tension contaminants, and thus having a high boiling temperature, providing a cooling device for the fumes.

### BACKGROUND

It is known to remove aromatic contaminants with low vapor pressure by condensation and adsorption on surfaces. However, this is effective for sub-micrometre contaminant particles requiring relatively low fume velocities across surfaces.

Alternatively, in particular to remove large quantities of organic contaminants, it is possible to apply chemical processes, for example by oxidating with thermal or catalytic incineration. In this case, however, complex and expensive devices are employed, which require large amounts of energy and, in addition, the incinerated fumes must be further treated. Furthermore, during oxidation, an additional reagent is often used compared to atmospheric air and this reagent requires the construction of a reaction chamber with a protective layer to avoid chemical aggression during the reaction; and further requires the management of such a reagent e.g. reagent level control, reagent supply etc.

### SUMMARY

The object of the present invention is to provide a method for the purification of fumes that is effective, constructively simple, and with low installation and operating costs and capable of exchanging thermal powers suitable for the application.

The object of the present invention is achieved by a method for purifying fumes with condensable gaseous contaminants, including the steps of:
Generating a flow of fumes to be treated in a heated area e.g. a heated room;
Cooling a three-dimensional or reticular cage or mesh structure, preferably multilayer, or monolithic with through pores or through channels made of a thermal conducting material, for example metallic or carbon-based such as graphene, by means of a cold thermal power source arranged in contact with a thermal conductor arranged between the cold thermal power source and said structure, so that the structure maintains a temperature lower than that of the fumes, the structure not being crossed by a flow of refrigerant fluid, to form an aerosol of suspended particles and condensates of said contaminants;
Adducting the aerosol into an inertial separator unit to carry out a separation of the condensed contaminants present in the aerosol
wherein the cold thermal power source is natural or artificial and is configured to stably and significantly maintain its temperature below the temperature of the fumes during the extraction of thermal power from the fumes through the cold structure.

The cold structure receiving the flow of fumes allows the contaminant to condense on the cold surfaces and induces the condensation of the contaminant vapors to obtain an aerosol which is subsequently separated by the inertial separator unit. The aerosol can also be generated by the detachment of liquid particles from the film that forms on the cold surface. It is also important to note that the heat exchange with the fumes affects the flow as a whole, thus favoring the efficiency of the nucleation and coalescence of condensed particles of the contaminants. Low vapor pressure contaminants, i.e. contaminants which at ambient pressure and temperature (about 100,000 Pa and 24° C.) are in the liquid state such as toluene, are present, for example, in bitumen fumes, fried foods, smokehouses, plasticizing substances, gummy substances, textiles or from processes with roasting or pyrolysis or carbonization. Furthermore, an inertial separator, i.e. a separator based on high fluid velocities which can be either centrifugal or with vane baffles e.g. “louver” type separator, is effective in separating small particles in aerosols from the gas flow. Furthermore, the structure is cooled by conduction in order to obtain low temperatures of the structure itself with high contaminant removal efficiencies. The conduction is operated through a solid conductor without the use of a flow of refrigerant fluid inside the structure. This conductor is, for example, arranged in contact with an evaporator of a refrigeration unit, i.e. an artificial source of cold power, and the cold from the evaporator propagates inside the conductor up to the structure surrounded in use by the fumes. In this way, the structure reaches with high efficiency temperatures much lower than the flow rate to be purified, e.g. of at least 100° C., preferably 150° C., even more preferably 200° C. lower than the temperature of the fumes and to maintain this temperature difference during the extraction of thermal power from the fumes towards the cold source. Furthermore, the nucleation process by condensation and separation is physical e.g. due to lowering of the temperature and non-chemical, i.e. free of chemical reactions between the contaminant and any acid or basic substances introduced for this purpose. The heat exchange with the structure i.e. condensation and inertial separation are both entirely physical processes and, for the purposes of the invention, at least during the cooling and inertial separation of the particles, no chemical reactions take place. This has the advantage of considerably simplifying the purification process and therefore also the components necessary for the construction of a purification plant, e.g. since it is not necessary to dose and supply chemical reagents and of protecting the devices, especially the structure and the inertial separator, in case of aggressive substances e.g. oxidizing or reducing agents. Furthermore, it is not even necessary to treat water or other substances after the purification process.

Preferably, the temperature of the structure is such as to trigger the condensation of the contaminants in the fumes but not so low as to cause the contaminants to solidify on the structure. For example, the structure maintains in use when receiving the fumes a temperature between the condensation temperature and the solidification temperature of at least one low-condensing contaminant of interest. In this way, the physical processes involved are both the generation of aerosols and the condensation on the structure. Furthermore, the operating temperature of the structure is the compromise between condensing most of the contaminant e.g. also on the surface of the structure, and evacuate the contaminant from the surface of the latter, e.g. by gravity. In particular, to facilitate evacuation by gravity, it is useful for the condensed contaminant to have a viscosity compatible with the type of structure on which the condensation occurs.

The method of the invention is also applicable to relatively small plants and can use a very common refrigeration plant, i.e. already present, or easily installed, both in industrial establishments and in commercial establishments such as kitchens e.g. of fast food etc. Furthermore, the cold source may be a reservoir of liquefied gas such as nitrogen or solidified gas such as carbon dioxide (dry ice), another example of an artificial cold thermal power source. In both cases, the temperature of the source remains substantially constant and significantly different from the temperature of the fumes while by conduction through the structure it extracts heat from the fumes. An example of a natural cold thermal power source is a land area having a very large, ideally infinite, heat capacity and a seasonally variable temperature within a range not exceeding 5° C., ideally constant throughout the year, such as groundwater or thaw, geothermal temperature of the ground more than 10 meters from the surface, i.e. where the influence of atmospheric events is negligible. A heat exchanger in thermal exchange with water or the ground is at a stably and significantly different temperature from that of the fumes during the withdrawal of the thermal power from the latter through the structure.

Preferably, the temperature of the cold thermal power source is monitored by a sensor and, in the case of artificial thermal power, an electronic control unit controls the refrigeration plant to keep the temperature of the cold thermal power source below a predefined threshold, in particular during the extraction of thermal power from the fumes.

By regulating the differential temperature between the fumes generated and the fluid, e.g. air, cold, the speed of the flow rates and the saturation level, it is possible to obtain satisfactory results for numerous contaminants even when the concentrations of the latter vary.

Substances are also used, i.e. air, water vapor, refrigerant fluid widely available and/or usable in closed circuit, lowering management costs. The inertial separator unit also contributes to this, notoriously easy to maintain in efficiency, also thanks to the cleaning operations that can be performed during operation, e.g. by simple action of gravity which allows the evacuation into a collection container and/or an automatic disposal conveyor belt. Alternately by scraping, shaking and vibrating.

According to a preferred embodiment, in order to regenerate the structure on which layers of condensed contaminants may be present, the method includes the step of heating the structure to a temperature such as to make said layers evaporate at least in part, after interrupting the heat conduction to the cold heat source.

Such heating can be performed in various ways e.g. switching off the refrigeration unit or otherwise interrupting the conduction of heat towards the source of cold thermal power and using the heat of the fumes to return the condensed layer adhering to the structure to the gaseous state, or switching off the heated area and connecting the structure to a source of heat with or without heat transfer fluid flow. In particular, in regeneration, the heat transfer fluid can be a cooling fluid from a thermal or chemical plant nearby and/or in the factory. Therefore, the structure never receives a refrigerant fluid during the extraction of thermal power from the fumes but can be heated by a heat transfer fluid during the regeneration phase i.e. elimination of the condensed layers adhering to the structure. It should also be noted that such regeneration as defined above is particularly advantageous because it can be performed without cooling the heated chamber (but in such a case releasing non-purified fumes) and without the need of dedicated components.

According to a preferred embodiment, the method includes the step of injecting an auxiliary fluid into the flue gas flow to be treated. According to a variant embodiment, a substance with a low vapor pressure, such as dipropylene glycol, is nebulized into the already at least partially cooled flow rate.

In this way, the enlargement of the contaminant particles is encouraged and this improves the effectiveness of the separation in the inertial separator group. Furthermore, the water is separated from the contaminant in the inertial separator unit and, in this way, can be reused e.g. in a closed circuit without further treatments or be released into the external environment with low or no environmental impact, in particular when the contaminant is not soluble in water, as in the case of oil used in food processes e.g. frying. However, it should be noted that the concentration or flow rate of substances that promote nucleation is minimal compared to that of the fumes, e.g. less than 10% and is generally monitored and regulated to maintain a predetermined value: these substances are not intended to substantially contribute to heat exchange.

According to a further embodiment, the heated chamber is closed by means of a door or flap and the fumes leaving the cyclonic separator are reintroduced into the heated chamber.

This is applicable for all processes, especially industrial ones, in which the atmosphere inside the chamber does not require replacement with fresh air or other gases which react chemically inside the chamber. The closed circuit of the fumes allows the passage in the cyclonic separator to be performed several times, increasing the quantity of contaminants eliminated. Furthermore, it is possible to avoid the connection of the chamber to a chimney for discharging the fumes into the atmosphere: this makes the retrofitting of already existing chambers or ovens particularly easy, i.e. it is not necessary to provide a connection to the chimney and/or to move the heated chamber inside the plant and therefore it is not necessary to redesign the connection to the chimney. The closed circuit of the fumes is particularly suitable in industrial processes in which the fumes are not generated as a result of chemical reactions, but contain gaseous pollutants generated by change of state e.g. from liquid to gaseous or from solid to gaseous, due to process temperatures. Furthermore, according to the present invention, the pressure in the chamber, except for the operation of the fan, is close to atmospheric pressure.

Other advantages of the present invention are discussed in the description and referred to in the dependent claims.

### BRIEF DESCRIPTION OF THE DRAWINGS

The invention is described below on the basis of non-limiting embodiments illustrated by way of example in the following figures, which refer respectively to:

FIG. 1 shows a schematic view of a plant for carrying out the method according to the present invention;

FIG. 2 shows an enlarged schematic view of the component of FIG. 1; and

FIGS. 3-5 refer to corresponding alternative embodiments of the cooling structure receiving the fumes.

### DETAILED DESCRIPTION OF THE EMBODIMENTS

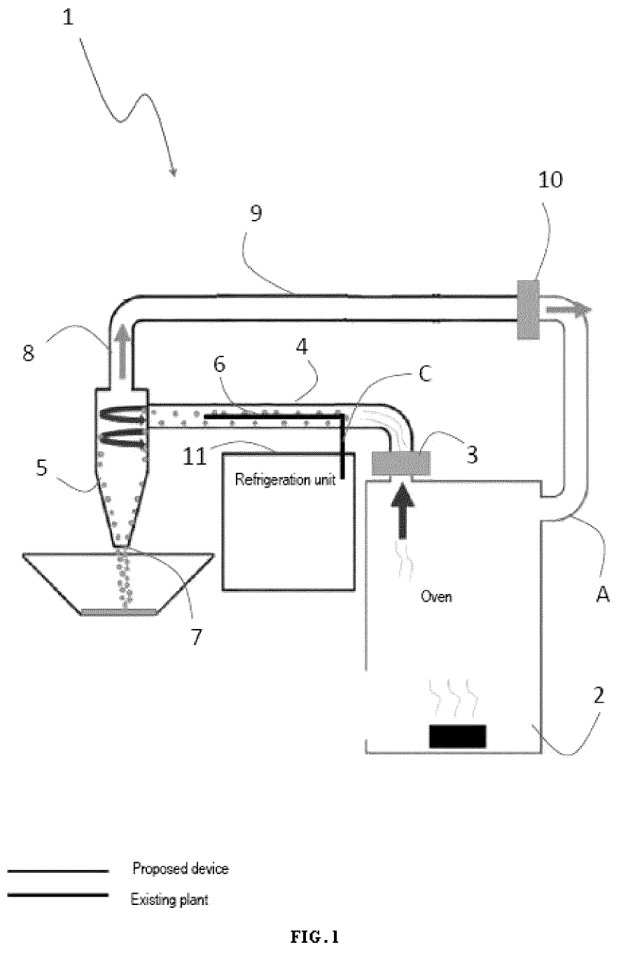

Number 1 in FIG. 1 shows as a whole a combined fume generation and purification plant including a heated chamber 2, preferably closed by a feed door, inside which a material is heated, generating fumes including low-vapor tension contaminants, such as an oven for curing an article including a thermosetting material such as an elastomer. However, it is also possible to apply the invention to fumes with gaseous impurities at low vapor pressure in other industrial sectors, such as coffee roasting or in the pyrolysis process, e.g. wood to obtain the so-called wood distillate or wood oil or pyroligneous oil. It is also possible to apply the invention also to fumes generated in open heated areas, such as in the presence of a fryer or a hob.

By means of a fan 3, the fumes to be treated are sucked from the heated chamber and conveyed into a duct 4.

Duct 4 carries the fumes towards an inertial separator 5 and houses a structure 6 made of a material with high thermal conductivity, e.g. metallic or carbon-based e.g. graphene, which is mainly cooled by conduction i.e. a flow rate of refrigerant fluid does not pass through structure 6. In particular, cold structure 6, preferably at a temperature at least about 100° C. lower than the condensation temperature of the target contaminant, induces a process of condensation of the contaminants in the portion of duct 4 through and downstream of structure 6 towards inertial separator 5. This involves the generation due to an exclusively physical phenomenon of an aerosol, i.e. a suspension of particles in which the terminal sedimentation velocity in air is less than 1 metre/second corresponds to spherical particles with a density of 1000 kg/m^3 with an equivalent aerodynamic diameter of about 180 micrometres.

The contaminants condensed on the surface or in the gas stream, but still suspended in the fumes gas flow in the form of aerosol particles, enter inertial separator 5 in which the separation process by inertial effect is favoured, i.e. at high speed and/or with deviations greater than 120°, of the particles whose condensation is induced by cold structure 6. For this purpose, inertial separator 5 includes an outlet 7 from which the condensed substances, e.g. by gravity and an outlet 8 for the air purified from the condensed substances. An example of another inertial separator that can be used is the Louver type (with baffles).

It is possible that the purified air is reintroduced into the atmosphere thus creating an open purification circuit. According to the embodiment of FIG. 1, a closed circuit of the fumes is created through a duct 9 to connect outlet 8 to heated chamber 2. Preferably a fan 10 generates a flow of purified air from inertial separator 5 to heated chamber 2 and, in particular, it generates a depression at outlet 8 which favors the separation between air and condensed particles. According to an embodiment not shown, it is possible to eliminate fan 3 and design fan 10 as a radial flow fan: in this way it is possible to process large fume gas flow rates and, at the same time, benefit from the geometry of the impeller to dispose of any particles of contaminants adhering to the impeller itself thanks to the centrifugal acceleration. The impeller is housed in a casing which will need to be periodically cleaned of the contaminant particles evacuated by centrifugal acceleration. Furthermore, fan 10 downstream of separator 5 applies a slight depression at the outlet of the separator itself with respect to atmospheric pressure.

Structure 6 is for example cooled by a refrigerating unit 11 including a closed circuit for a heat transfer fluid and in a known way it removes heat from a conductor C connected in thermal conduction without supplying the cooling fluid to the structure via an evaporator in which the heat transfer fluid passes to be subsequently sucked in by a compressor and release heat to the outside via a condenser. In order to obtain the temperatures suitable for making the condensation process of the contaminants in the fumes efficient, e.g. temperatures decidedly lower than the condensation temperature but higher than the solidification temperature of the contaminant, the refrigerating unit can be two-stage with double lamination and double compression and the heat transfer fluid is carbon dioxide (R-744) to run a subcritical cycle with the evaporator around at −30° C.

Furthermore, in view of the low operating temperatures, conductor C is preferably insulated so as not to get too hot between refrigeration unit 11 and structure 6. Furthermore, an insert of thermally insulating material is arranged between conductor C and a wall of duct 4 to avoid differential thermal expansion shock and fume leaks.

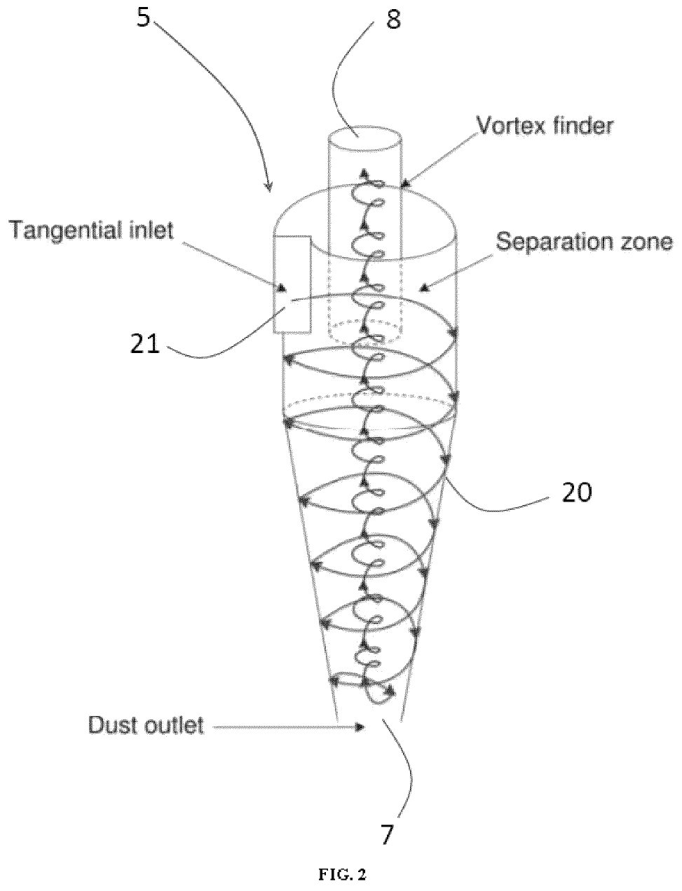

FIG. 2 illustrates a preferred embodiment of inertial separator 5. It is a cyclonic separator including a main hollow body 20 open downwards to define outlet 7 and defining a surface converging towards outlet 7 itself. Hollow main body 20 is elongated and, on the longitudinal side opposite outlet 7, defines a preferably tangential inlet 21 and outlet 8.

Through fan 3 and/or 10, the flow of fumes enters main hollow body 20 with a predetermined kinetic energy through inlet 21 and, thanks to the shape converging downwards of body 20, favors the separation of the condensed particles for coalescence and growth thanks to the centrifugal force. The increasingly larger and heavier particles tend to leave outlet 7 by gravity. On the contrary, the purified and lightened air tends to flow towards the center of body 20 and come out of outlet 8, also thanks to the depression generated by fan 10.

During a washing phase of separator 5, a fluid is injected through a special upper opening so as to remove residues adhering to the walls on which the coalescent particles grow. This fluid, whose composition varies depending on the contaminant of the fumes, is evacuated from outlet 7. During washing, the separation and therefore purification action is not compromised. However, when the contaminant is recovered, as in the case of ‘wood oil’ generated during a pyrolysis process, the scrubbing fluid is mixed with the condensed contaminant and then either the mixture is discarded or it must be further treated to separate the fluid of washing.

According to the invention, it is possible to retrofit a pre-existing heated chamber, e.g. an oven, to obtain the advantages of the invention. In this case, fumes of the heated chamber, possibly already equipped with its own fan 3, is connected to inertial separator 5 via duct 4 arranged to house structure 6. The latter is cooled by the refrigerating unit 11 suitably installed or connected, as pre-existing as the heated room but intended for other purposes. Optionally, the flue gas circuit is closed via duct 9 with the correspondent fan, possibly pre-existing, connected to an air intake A of chamber 2. Even the cold air circuit, if the fumes circuit is closed, can also be closed by connecting duct 9. According to a preferred embodiment, there are two fans, one between the heated chamber and the inertial separator to force a current of air to be treated and another between the inertial separator and the external environment or the heated room to force a stream of treated air and thus balance the air circuit.

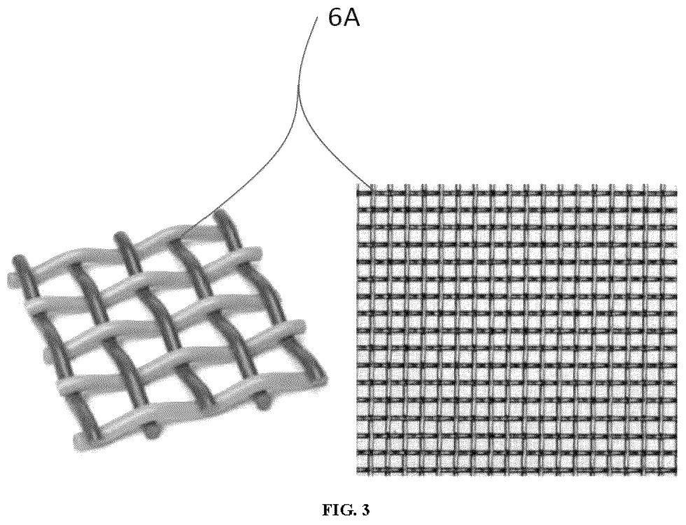

FIG. 3 shows a first embodiment of the mesh structure 6A. The mesh is preferably made of solid section rod of a metallic material and has large openings i.e. such as not to significantly impact the resistance to the passage of fumes. The mesh structure with large openings has the purpose of uniforming the cold temperature over the entire cross section of duct 4 so as to favor an extensive nucleation of condensed particles. In particular, structure 6A includes a plurality of mesh layers so as to increase the thermal power extracted from the fumes, without causing excessive resistance to flow of the fumes.

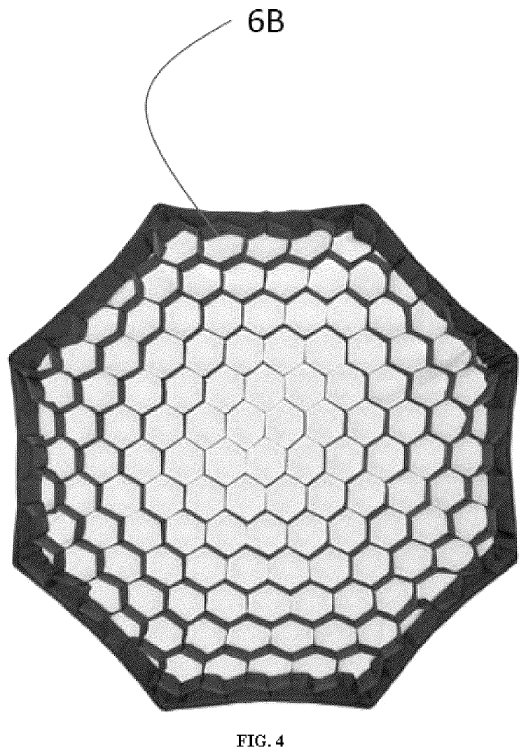

FIG. 4 shows a second embodiment of the mesh structure 6B in which the large aperture lattice is defined by walls of a metallic material e.g. defining a honeycomb or other regular pattern structure. Again, structure 6 is three-dimensional with walls having a suitable depth, high width i.e. to allow the extraction of the desired thermal power, or a plurality of structures 6B whose walls have an overall width capable of extracting the desired thermal power.

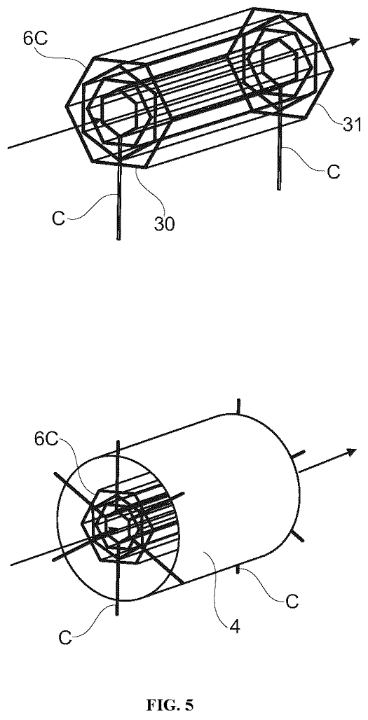

FIG. 5 shows a third embodiment of the three-dimensional frame structure 6C, for example a set of concentric squirrel cages.

In use, the fumes coming out of chamber 2 including suspended contaminants are adducted by means of duct 4 through structure 6 housed, preferably coaxially, in duct 4 and including, in the frame embodiment, at least two frames 30, 31 arranged transversal to the fumes flow and facing along the direction of the flow; said frames 30, 31 being connected to each other longitudinally by slender metal elements, e.g. wires or bars, so as to form frame structure 6 housed inside duct 4. As shown in the FIG. 5, it is possible to provide several nested frames, e.g. in concentric configuration so as not to significantly impact on the resistance to the flow of the fumes and at the same time distribute low temperature conductors so as to affect the entire cross section of duct 4. The complication of the geometry of the slender elements e.g. the number, length and orientation in space provide the designer with the parameters for sizing the thermal power extracted from the fumes.

According to an embodiment not shown, structure 6 can also be regular or irregular trabecular with through pores or through cells so as to significantly increase the surface/volume ratio and thus favor the cooling of the fumes. Such structures can be realized in various ways e.g. through an additive technique starting from metal powders. Thanks to the through cells, the fumes pass through the structure towards inertial separator 5 and, during this passage, they are cooled.

It is also possible to monitor the purification of the fumes, and in particular the heat exchange of structure 6, by means of suitable sensors and a control unit which receives the signals of these sensors as input. For example, a sensor is arranged to detect the temperature of the cold thermal power source and another sensor detects the fumes temperature upstream of structure 6. With reference to the cold thermal power source, on the basis of the relevant temperature sensor which detects during the extraction of thermal power from the fumes, it is possible, in case of increasing temperature over time:
in the case of an artificial source either generating a warning message e.g. to indicate that a new quantity of liquefied gas must be supplied or adjusting the cooling system to keep the source temperature below a predefined threshold;
in the case of a natural source e.g. an aquifer or a geothermal layer of soil, generating a warning message if the temperature of the source exceeds a predefined temperature threshold.

According to a preferred embodiment, it is possible to provide for a regeneration of structure 6 to eliminate condensed substances adhering to the structure itself. For example, it is possible to mechanically interrupt the thermal conduction with the cold thermal power source e.g. by means of a sliding spline coupling in which a slider is movable between a coupled position in which thermal conduction extracts thermal power from the fumes via structure 6 towards the source and an uncoupled position in which such conduction is interrupted. In the latter configuration, the fumes heat structure 6 bringing the adhering condensed substances back to the gaseous state. Alternatively or in combination, when conduction to the cold heat power source is interrupted, the structure may be heated by a heating heat transfer fluid.

Finally, it is clear that modifications or variations can be applied to the method described and illustrated here without thereby departing from the scope of protection as defined by the attached claims.

For example, it is possible to inject a low vapor pressure liquid so that downstream of the fumes cooling point, the particles in the aerosol increase their mass so as to favor their capture in separator 5. Water, for some condensed contaminants such as organic matter in the fumes originating from the use of oils such as during frying, can be separated from the condensed contaminants after leaving the inertial separator.

It is also possible to dehumidify the air before cooling it in refrigeration unit 11.

According to not shown embodiment, the walls of cyclonic separator 5 (or Louver) are cooled by e.g. a cold fluid fed into an exchanger, the fluid being for example branched from refrigeration unit 11.

According to a not shown embodiment, the structure is monolithic with through cells with channels for the passage of fumes arranged in a regular manner e.g. in a similar way to a monolithic structure used in a catalytic converter. For example, such a monolith is made of a carbon-based material, e.g. graphene, thermally conductive.

According to an embodiment of the present invention, when the cold heat power source is thermostatized e.g. is either natural or based on liquefied gas, a method of controlling the temperature of structure 6 includes dividing the structure into at least two sub-structures, each of which is monitored by a corresponding temperature sensor. Each sub-structure can be disconnected from the cold thermal power source, for example as indicated in the previous paragraphs. A control unit receiving the signals from the temperature sensors is also programmed to connect the downstream sub-structure to the cold thermal power source when the temperature of the upstream sub-structure exceeds a pre-defined threshold e.g. the condensing temperature of the low-condensing contaminant. Furthermore, the control unit is programmed to disconnect the downstream sub-structure from the cold thermal power source when the temperature of the corresponding sensor drops below a predetermined threshold, e.g. the solidification temperature of the contaminant in the fumes. In this way, if the first sub-structure does not extract sufficient thermal power from the fumes to reach condensation, via the heat transfer connection with the source of cold thermal power, the downstream sub-structure receives colder fumes and therefore the temperature of these fumes, during the passage, can drop below the condensation temperature. Through an appropriate sizing it is possible to define both the total number of sub-structures and the size e.g. of the exchange surface, of each sub-structure. Similarly, in case of excessive thermal power extracted by the sub-structures, the downstream sub-structure is disconnected from the cold thermal power source to prevent the contaminant from solidifying on the sub-structure.

Alternatively, it is possible for structure 6 to be connected to one or more sources of cold thermal power via a plurality of thermal conductors e.g. longitudinally equally spaced. In this case, each thermal conductor corresponds to a temperature sensor to monitor the longitudinal temperature gradient along the structure during the passage of the fumes and connect/disconnect the thermal conductors on the basis of the previous paragraph.

According to a not shown embodiment, the inertial separator is a separator with a “louver” type baffle deflector, for the purpose of separating large-sized particles. It is also possible to arrange in series an inertial baffle separator upstream and a cyclonic inertial separator downstream: the former is effective with relatively large particles and the latter can remove smaller sized aerosol particles.

It is also possible to associate a natural cold thermal power source with an artificial cold thermal power source that can be activated when the thermal power extracted through the natural cold thermal power source is not sufficient to condense the contaminants in the fumes. Such actuation is performed on the basis of the temperature of structure 6.

What is claimed is:

1. A method of fume purification from condensable airborne contaminants, comprising the following steps:
generating in a heated area a flow of fumes to be treated;
cooling a three-dimensional frame or mesh structure, wherein the three-dimensional frame or mesh structure is made of a cold conducting material, the step of cooling the three-dimensional frame or mesh structure is conducted by means of a cold thermal power source in contact with a cold conductor, wherein the cold conductor is arranged between the cold thermal power source and the three-dimensional frame or mesh structure, wherein the three-dimensional frame or mesh structure has a temperature lower than a temperature of fumes, the three-dimensional frame or mesh structure not being crossed by a flow of refrigerant fluid, to form an aerosol of nucleated and suspended particles of the condensable airborne contaminants;
adducting by a fan the aerosol into an inertial separator unit to carry out a separation of contaminants condensed in the aerosol, wherein the cold thermal power source is natural or artificial and is configured to stably and sensibly keep a temperature of the cold thermal power source below the temperature of the fumes during an extraction of thermal power from the fumes through the three-dimensional frame or mesh structure.

2. The method according to claim 1, further comprising a step of monitoring, wherein the temperature of the cold thermal power source and/or the temperature of the three-dimensional frame or mesh structure is monitored by a temperature sensor during the extraction of the thermal power from the fumes.

3. The method according to claim 2, comprising a step of generating a warning signal or a step of controlling the cold thermal power source or a connection in a thermal conduction of the three-dimensional frame or mesh structure with the cold thermal power source, based on the temperature sensor.

4. The method according to claim 1, comprising a step of controlling the temperature of the three-dimensional frame or mesh structure, wherein the condensable airborne contaminant condenses and does not systematically and extensively solidify on the three-dimensional frame or mesh structure.

5. The method according to claim 4, wherein the step of controlling the temperature of the three-dimensional frame or mesh structure comprises a step of adjusting the temperature of the cold thermal power source and a step of changing a cooled surface exposed to the flow of fumes by connecting and disconnecting a thermal conductor of at least one section.

6. The method according to claim 4, wherein the step of controlling the temperature of the three-dimensional frame or mesh structure comprises a step of connecting/disconnecting a thermal conductor.

7. The method according to claim 1, comprising steps of disconnecting a thermal conduction to the cold thermal power source and subsequently heating the three-dimensional frame or mesh structure to a temperature to at least partially evaporate condensed layers of contaminants deposited in use on the three-dimensional frame or mesh structure by the flow of fumes.

8. The method according to claim 1, comprising a step of injecting a low vapor tension substance in the flow of fumes to be treated upstream of the inertial separator unit.

9. The method according to claim 1, comprising a further step of adducting purified air exiting the inertial separator unit into the heated area, wherein the heated area is a chamber, to create a closed fume circuit.

10. The method according to claim 1, wherein the step of cooling the three-dimensional frame or mesh structure comprises a step of placing a refrigeration unit that, via a thermal conductor, transmits cooling power to the three-dimensional frame or mesh structure.

11. The method according to claim 10, wherein the refrigeration unit is a carbon dioxide with double compression and double lamination unit.

12. The method according to claim 1, wherein the inertial separator unit is cyclonic and/or Louver.

13. The method according to claim 1, wherein the heated area is selected from a pyrolysis chamber for wood, or a curing chamber, or a coffee toasting chamber.

14. The method according to claim 1, wherein the heated area is a fryer or a hob.

15. The method according to claim 1, wherein in the step of cooling the three-dimensional frame or mesh structure, the three-dimensional frame or mesh structure is a multi-layer or through pores/channels.
